(19) United States
(12) Patent Application Publication
(10) Pub. No.: US 2013/0287483 A1
(43) Pub. Date: Oct. 31, 2013

(54) FURNITURE CONNECTING PIECE

(71) Applicants: Minshen Liu, Dongguan (CN); Yuqi Liu, Dongguan (CN)

(72) Inventors: Minshen Liu, Dongguan (CN); Yuqi Liu, Dongguan (CN)

(21) Appl. No.: 13/997,927

(22) PCT Filed: Dec. 14, 2011
(86) PCT No.: PCT/CN11/83935

§ 371 Date: Jun. 25, 2013

(30) Foreign Application Priority Data
Dec. 30, 2010 (CN) 201010614448.3

(51) Int. Cl. F16B 5/10

(52) U.S. Cl. CPC F16B 5/10
USPC 403/287

(57) ABSTRACT

A furniture connecting piece includes a base having an upper end face and a lower end face. The furniture connecting piece also comprises a positioning plate and a fixing nail. The bottom of the positioning plate is connected to the base. The positioning plate is provided with a fixing hole through which the fixing nail passes to fix the positioning plate onto a furniture panel. The furniture connecting piece is structurally simple and convenient to use, and allows for seamless connection between furniture panels without necessitating the aid of tools, thereby convenient and practical.

### FIELD OF THE INVENTION

The invention relates to a connecting piece, more particularly, a furniture connecting piece.

### BACKGROUND OF THE INVENTION

The various parts of the traditional furniture are usually assembled by permanent connection way which not only results that the furniture is easily damaged during the movement and transportation but also increases the transportation cost because of large volume of the furniture. In order to resolve the problems, most of the furniture at present is designed to be detachable, which enable the furniture to be disassembled into various parts for package when not in use or transportation. This not only reduces the space the furniture occupies and the cost during transportation but also effectively avoids damage because of collision during transportation.

Now, the various parts of the disassemble furniture in the market are usually connected by methods of fitting screws with screw base or fitting screw with hinge, the disadvantages of the methods are as follows: it needs to punch hole at the connecting position in the furniture, if used for a long time the screw port will expands and the stability will worse, the unstable connection easily causes the furniture to damage; the expanding joint gaps between the various parts of the furniture will influence the appearance of the furniture, no matter the disassembly process or the assembly process is complicated and needs to use tools.

### SUMMARY OF THE INVENTION

To overcome the above-mentioned drawbacks, an object of the present invention is to provide a furniture connecting piece which achieves the seamless connection between furniture panels without necessitating the aid of tool, thereby convenient to use and simple to produce.

To achieve the above object, the furniture connecting piece in accordance with one aspect of the present invention comprises a base with an upper end face and a lower end face, a positioning plate, and a fixing nail. A bottom of the positioning plate is connected to the base, and the positioning plate is provided with a fixing hole through which the fixing nail passes to fix the positioning plate onto a furniture panel.

Preferably, the base has a containing groove defined in the upper end face thereof. A rotating shaft is provided in the containing groove. The bottom of the positioning plate is provided with a through hole, and the rotating shaft passes through the through hole to connect the poisoning plate with the base.

The containing groove is configured to match the positioning plate, and the positioning plate is rotatable about the rotating shaft so that the positioning plate can be contained in whole or in part in the containing groove or protrude from the containing groove.

As one embodiment, the positioning plate has a top opposite to the bottom thereof, and between the top of the positioning plate and an inner wall of the containing groove when the positioning plate contains in the containing groove there is a gap for easily pulling up the positioning plate.

The top of the positioning plate is provided with a recess for easily pulling it up.

As another embodiment, the top of the positioning plate abuts an inner wall of the containing groove and provides a pick extending outside the containing groove for easily pulling up the positioning plate.

The base is oval-track shaped, two opposite sides of the upper end face of the base each define a nail hole, and two opposite sides of the lower end face each define a slit extending toward the upper end face and communicating with the corresponding nail hole.

The outer surface of the base is provided with pawls.

A combinational panel in accordance with another aspect of the present invention comprises a first furniture panel and a second furniture panel. The first furniture panel is provided with a mounting groove, and the second furniture panel is provided with a mounting hole. The first furniture panel and the second furniture panel are connected by a furniture connecting piece which comprises a base with an upper end face and a lower end face, and the base is mounted in the mounting groove. The furniture connecting piece further comprises a positioning plate and a fixing nail. A bottom of the positioning plate is connected with the base, the positioning plate is provided with a fixing hole, and the fixing nail passes through the fixing hole and the mounting hole to fix the positioning plate onto the second furniture panel, thereby connecting the first furniture panel with the second furniture panel.

The advantages of the present invention are as follows: the furniture connecting piece in the present invention is structurally simple and convenient to use, and allows for seamless connection between furniture panels without necessitating the aid of tools, thereby convenient and practical.

### DESCRIPTION OF THE DRAWINGS

FIG. 1 is a perspective view of a furniture connecting piece in accordance with a first embodiment of the present invention.

FIG. 2 is a perspective view of a furniture connecting piece in accordance with a second embodiment of the present invention.

FIG. 3a is a perspective view of a furniture connecting piece in accordance with a third embodiment of the present invention.

FIG. 3b is another perspective view of the furniture connecting piece in accordance with the third embodiment of the present invention.

FIG. 4a is a perspective view of a furniture connecting piece in accordance with a fourth embodiment of the present invention.

FIG. 4b is another perspective view of the furniture connecting piece in accordance with the fourth embodiment of the present invention.

FIG. 5 is an exploded perspective view of a combinational panel in accordance with the present invention, in which the furniture connecting piece is that showed in the third embodiment.

### DETAILED DESCRIPTION OF ILLUSTRATED EMBODIMENTS

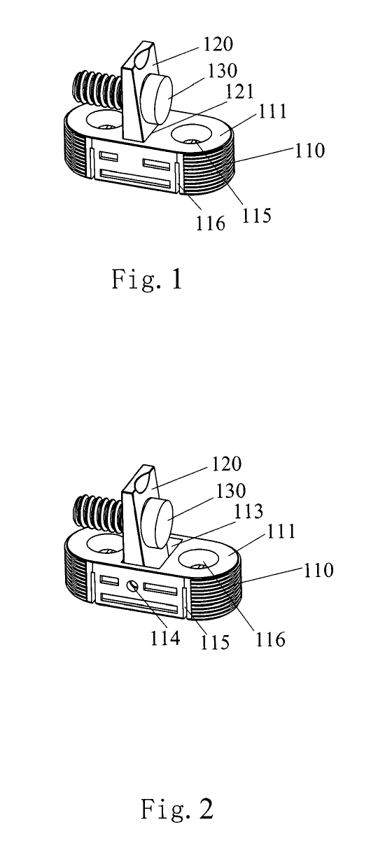

Referring to FIG. 1, FIG. 1 is a perspective view of the first embodiment of the furniture connecting piece in the invention. The furniture connecting piece 100 includes a base 110 with an upper end face 111 and a lower end face 112 (not show), the connecting piece further comprises a positioning plate 120 and a fixing nail 130, the bottom 121 of the positioning plate is connected to the base 110, and the positioning plate 120 is provided with a fixing hole 123 through which the fixing nail 130 passes to fix the positioning plate 120 onto a furniture panel.

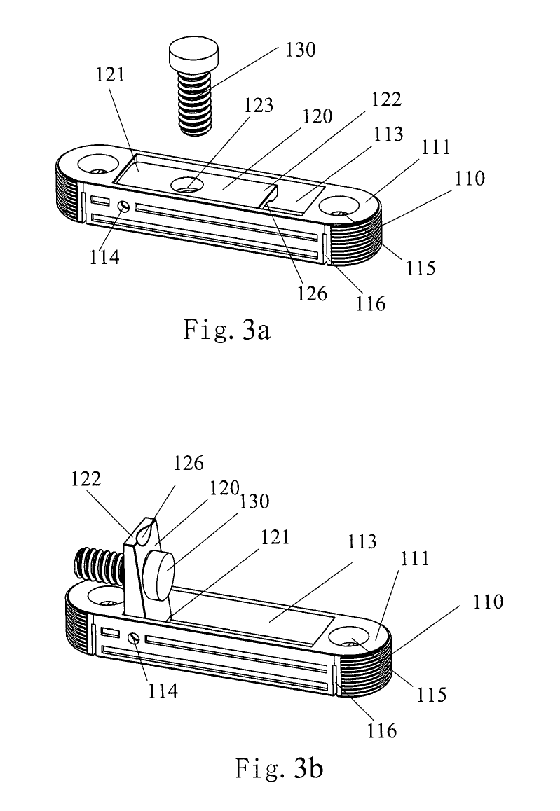

Preferably, referring to FIG. 2, FIG. 2 is a perspective view of the second embodiment of the furniture connecting piece in the invention. The base 110 has a containing groove 113 defined in its upper end face thereof, a rotating shaft 114 is provided in the containing groove 113. The bottom 121 of the positioning plate is provided with a through hole 122 (not show), and the rotating shaft 114 passes through the through hole 122 to connect the positioning plate 120 with the base 110.

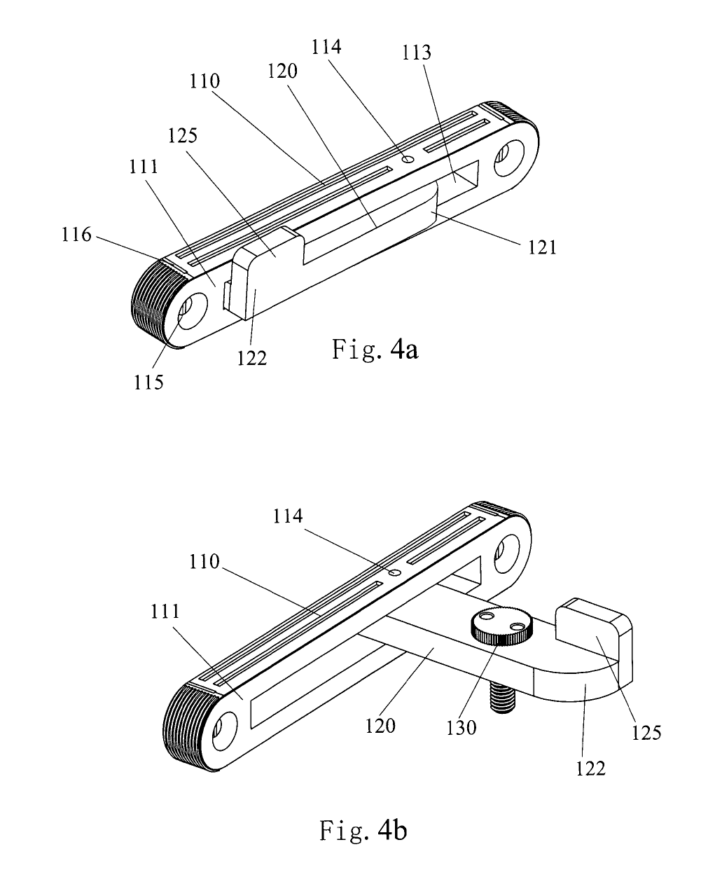

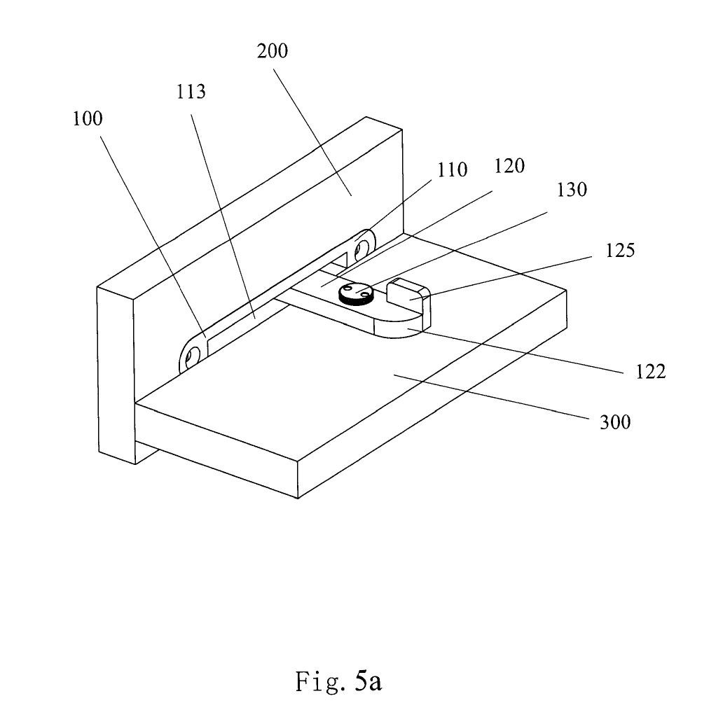

Referring to FIG. 3a, FIG. 3b, FIG. 4a and FIG. 4b, they are the perspective views of the third and the fourth embodiments of the furniture connecting piece in the invention. The containing groove 113 is configured to match the positioning plate 120, and the positioning plate 120 is rotatable about the rotating shaft 114 so that the positioning plate 120 can be contained in whole or in part in the containing groove 113 (showed in FIG. 3a and FIG. 4a) or protrude from the containing groove 113 (showed in FIG. 3b and FIG. 4b).

The positioning plate 120 has a top 122 opposite to the bottom 121 thereof, and between the top 122 of the positioning plate 120 and an inner wall 144 of the containing groove 113 when the positioning plate 120 contains in the containing groove 113 there is a gap for easily pulling up the positioning plate 120. The top 122 of the positioning plate 120 is provided with a recess 126 for easily pulling up the positioning plate 120.

Preferably, referring to FIG. 4a, when the positioning plate 120 contains in part in the containing groove 113, the top 121 of the positioning plate 120 abuts the inner wall 114 of the containing groove 113 and provides a pick 125 extending outside the containing groove 113 for easily pulling up the positioning plates 120.

Referring to FIG. 1, FIG. 2a, FIG. 3a and FIG. 4a, the base 110 is oval-rack shaped. Two opposite sides of the upper end face 111 of the base each define a nail hole 115, and two opposite sides of the lower end face 112 each define a slit 116 extending toward the upper end face 111 and communicating with the corresponding nail hole 115.

The outer surface of the base 110 is provided with pawls 117.

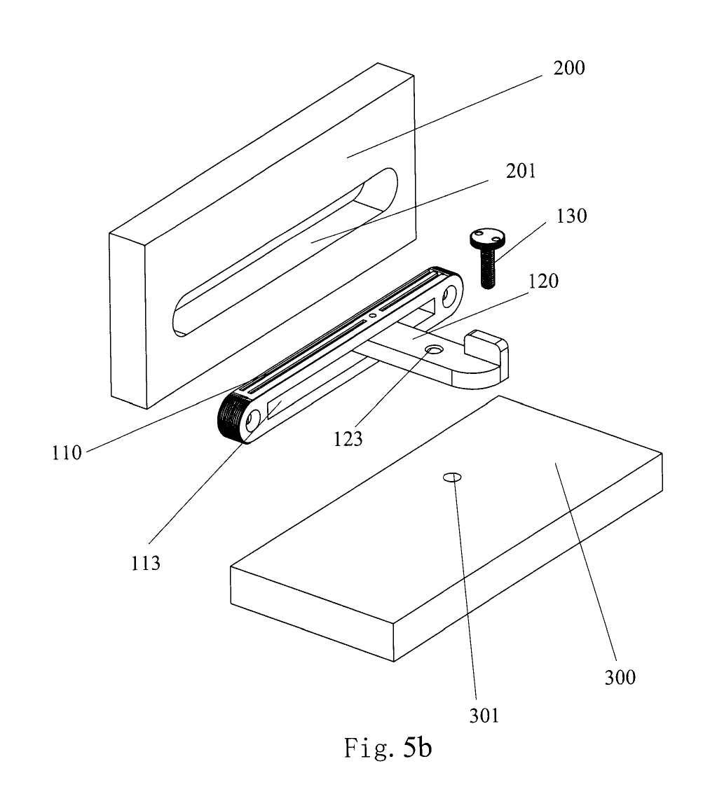

Referring to FIG. 5, a combinational panel comprises a first furniture panel 200 and a second furniture panel 300. The first furniture panel 200 is provided with a mounting groove 201, and the second furniture panel 300 is provided with a mounting hole 301, the first furniture panel 200 and the second furniture panel 300 are connected by a furniture connecting piece which includes a base 100 with an upper end face 111 and a lower end face 112. The base 100 is mounted in the mounting groove 201. The furniture connecting piece further comprises a positioning plate 120 and a fixing nail 130. The bottom 121 of the positioning plate 120 is connected to the base 110. The positioning plate 120 is provided with a fixing hole 123, and the fixing nail 130 passes through the fixing hole 123 and the mounting hole 301 to fix the positioning plate 120 onto the second furniture panel 300, thereby connecting the first furniture panel 200 with the second furniture panel 300.

While the invention has been described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention.

1. A furniture connecting piece, comprising a base with an upper end face and a lower end face, and being characterized in that said furniture connecting piece further comprises a positioning plate and a fixing nail, a bottom of said positioning plate is connected to said base, and said positioning plate is provided with a fixing hole through which said fixing nail passes to fix said positioning plate onto a furniture panel;
wherein said base has a containing groove defined in said upper end face thereof, a rotating shaft is provided in said containing groove, said bottom of said positioning plate is provided with a through hole, said rotating shaft passes through said through hole to connect said poisoning plate with said base;
wherein said containing groove is configured to match said positioning plate, and said positioning plate is rotatable about said rotating shaft so that said positioning plate can be contained in whole or in part in said containing groove or protrude from said containing groove.

2-3. (canceled)

4. The furniture connecting piece according to claim 1, wherein said positioning plate has a top opposite to the bottom thereof, and between said top of said positioning plate and its facing inner wall of said containing groove when said positioning plate contains in said containing groove there is a gap for easily pulling up said positioning plate.

5. The furniture connecting piece according to claim 4, wherein said top of said positioning plate is provided with a recess for easily pulling up said positioning plate.

6. The furniture connecting piece according to claim 1, wherein said positioning plate has a top opposite to the bottom thereof, said top of said positioning plate abuts an inner wall of said containing groove and provides a pick extending outside said containing groove for easily pulling up said positioning plate.

7. The furniture connecting piece according to claim 1, wherein said base is oval-rack shaped, two opposite sides of said upper end face of said base each define a nail hole, and two opposite sides of said lower end face each define a slit extending toward said upper end face and communicating with the corresponding nail hole.

8. The furniture connecting piece according to claim 1, wherein an outer surface of said base is provided with pawls.

9. A combinational panel, comprising a first furniture panel and a second furniture panel wherein said first furniture panel is provided with a mounting groove, said second furniture panel is provided with a mounting hole, said first furniture panel and said second furniture panel are connected by a furniture connecting piece which comprises a base with an upper end face and a lower end face, and said base is mounted in said mounting groove, the combinational panel being characterized in that said furniture connecting piece further comprises a positioning plate and a fixing nail, a bottom of said positioning plate is connected with said base, said positioning plate is provided with a fixing hole, and said fixing nail passes through said fixing hole and said mounting hole to fix said positioning plate onto said second furniture panel, thereby connecting said first furniture panel with said second furniture panel;
wherein said base has a containing groove defined in said upper end face thereof, a rotating shaft is provided in said containing groove, said bottom of said positioning plate is provided with a through hole, said rotating shaft passes through said through hole to connect said poisoning plate with said base;
wherein said containing groove is configured to match said positioning plate, and said positioning plate is rotatable about said rotating shaft so that said positioning plate can be contained in whole or in part in said containing groove or protrude from said containing groove.
